(19) United States
(12) Patent Application Publication
(10) Pub. No.: US 2012/0326524 A1
(43) Pub. Date: Dec. 27, 2012

(54) NON-CONTACT POWER TRANSMISSION DEVICE

(76) Inventors: Takaoki Matsumoto, Shiga-ken (JP); Atsushi Isaka, Shiga-ken (JP); Kazuhiro Suzuki, Shiga-ken (JP); Kyohei Kada, Kyoto (JP); Yoshihide Kanakubo, Osaka (JP); Yohei Nagatake, Kanagawa-ken (JP); Hideyuki Kihara, Kanagawa-ken (JP)

(21) Appl. No.: 13/582,228

(22) PCT Filed: Mar. 29, 2011
(86) PCT No.: PCT/JP2011/057763

§ 371 Date: Aug. 31, 2012

(30) Foreign Application Priority Data
Apr. 19, 2010 (JP) 2010-096126

(51) Int. Cl. H02J 17/00

(52) U.S. Cl. 307/104

(57) ABSTRACT

A portable terminal is activated when receiving verification power transmitted in a contactless manner from a charger using electromagnetic coupling between the charger and the portable terminal. The portable terminal sends an electrical signal (wakeup frame) indicating activation immediately after being activated to the charger. Reception of the wakeup frame triggers the power transmitting device to start a verification process on the power receiving device and perform a detection process for a metal foreign object. After authentication is established, the charger transmits normal power to the portable terminal.

### RELATED APPLICATIONS

This application is the U.S. National Phase under 35 U.S.C. §371 of International Application No. PCT/JP2011/057763, filed on Mar. 29, 2011, which in turn claims the benefit of Japanese Application No. 2010-096126, filed on Apr. 19, 2010, the disclosures of which Applications are incorporated by reference herein.

### TECHNICAL FIELD

The present invention relates to a contactless power transmission device that transmits power in a contactless manner between a power transmitting electric device and a power receiving electric device through electromagnetic coupling.

### BACKGROUND ART

As described in, for example, patent document 1, a contactless power transmission apparatus of the prior art includes a power transmitting electric device, such as a charger (cradle), and a power receiving electric device, such as a cellular phone. The power transmitting electric device is electromagnetically coupled to the power receiving electric device to transmit power in a contactless manner to the power receiving electric device. The power receiving electric device uses the power transmitted in a contactless manner to charge an incorporated rechargeable battery.

In the contactless power transmission apparatus, when the power receiving electric device is arranged on the power transmitting electric device, it is determined whether or not the two electric devices are in a correct positional relationship based on the voltage induced at the power transmitting electric device. When the positional relationship is correct, communication using electromagnetic coupling between the two electric devices is performed to verify whether or not the device set on the transmitting side electric device is a correct device that should be set. When the verification is successful, continuous normal power transmission is started.

A metal foreign object may be arranged between the power transmitting electric device and the power receiving electric device. In this case, eddy current is generated at the metal foreign object, and Joule heating may occur in the metal foreign object. Thus, in the contactless power transmission device, detection for a metal foreign object is performed during a normal power transmission period. When a metal foreign object is detected, power transmission is stopped. This suppresses heating of the metal foreign object.

### PRIOR ART DOCUMENT

### Patent Document

Patent Document 1: Japanese Laid-Open Patent Publication No. 2009-189230

### SUMMARY OF THE INVENTION

### Problems that are to be Solved by the Invention

However, the contactless power transmission device of patent document 1 has a shortcoming in that when power transmission is performed under an environment in which a metal foreign object is present, the metal foreign object may be heated to a high temperature as described above. A person may touch the heated metal foreign object. Thus, it is desirable that a metal foreign object be detected as soon as possible. In this regard, the contactless power transmission device of patent document 1 performs metal foreign object detection during the normal power transmission period after the electric device set on the transmitting side electric device is successfully verified. In other words, metal foreign object detection is not performed before the normal power transmission starts, such as during the verification period. In the contactless power transmission device of patent document 1, prior to the normal power transmission, power is transmitted from the power transmitting electric device to the power receiving electric device to determine the positional relationship and verify the receiving side electric device. This may heat a metal foreign object during, for example, the verification period. In this regard, there is room for improvement in the contactless power transmission apparatus of patent document 1.

Accordingly, it is an object of the present invention to provide a contactless power transmission device that detects a metal foreign object at an early stage.

### Means for Solving the Problem

One aspect of the present invention provides a contactless power transmission device including a power transmitting device and a power receiving device. The power receiving device is activated when receiving verification power transmitted in a contactless manner from the power transmitting device using electromagnetic coupling between the transmission device and the power receiving device. After the power receiving device is activated, the power transmitting device transmits normal power to the power receiving device when verification of the power receiving device is successfully performed through communication using the electromagnetic coupling. The power receiving device transmits to the power transmitting device an electric signal indicating activation immediately after being activated upon receipt of the verification power. Reception of the electric signal triggers the power transmitting device to start a verification process on the power receiving device and perform a detection process for a metal foreign object.

In one example, the power receiving device includes a clock generator that generates a clock signal used to generate a data frame of a signal transmitted to the transmission device when supplied with power. The power receiving device transmits the electric signal when determining activation at a timing at which the clock generator stably generates the clock signal.

In one example, as the detection process for a metal foreign object, the power transmitting device detects an input current from an external power supply and performs a comparison process on the value of the detected current and a preset foreign object determination threshold. In this case, the power transmitting device determines that a metal foreign object is present when the value of the detected current exceeds the foreign object determination value.

In one example, the power receiving device includes a rechargeable battery and uses power transmitted in a contactless manner from the power transmitting device to charge the rechargeable battery.

In one example, the verification power and the normal is transmitted by the electromagnetic coupling from the power transmitting device to the power receiving device, the verification power is AC power oscillated from the power transmitting device and having a modulated frequency, and the normal power is AC power oscillated from the power transmitting device and having a predetermined frequency.

In one example, the power receiving device transmits the electric signal indicating activation to the power transmitting device after receiving the verification power and before receiving the normal power.

### Effect of the Invention

The present invention starts a detection process for a metal foreign object before starting normal power transmission and can thus detect a metal foreign object at an early stage.

### BRIEF DESCRIPTION OF THE DRAWINGS

FIG. 1 is a block diagram of a contactless charging apparatus.

FIG. 2 is a perspective view of the contactless charging apparatus.

FIG. 3 is a flowchart showing the control executed by a charger.

FIG. 4 is a flowchart of a verification process performed between the charger and a portable terminal.

FIGS. 5A to 5E are activation sequence diagrams of the portable terminal.

### EMBODIMENTS OF THE INVENTION

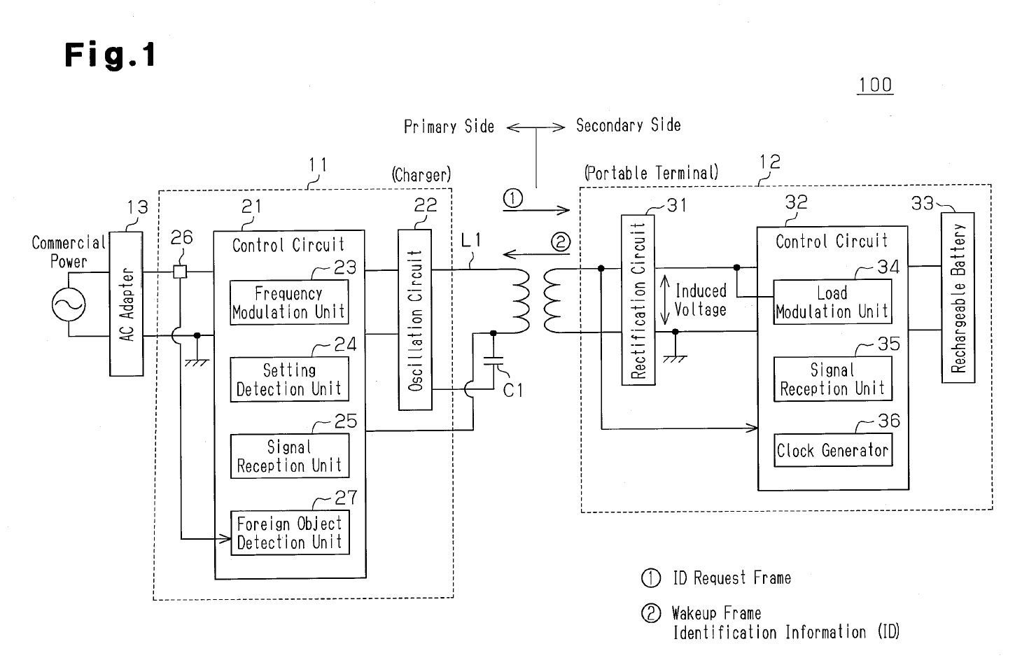

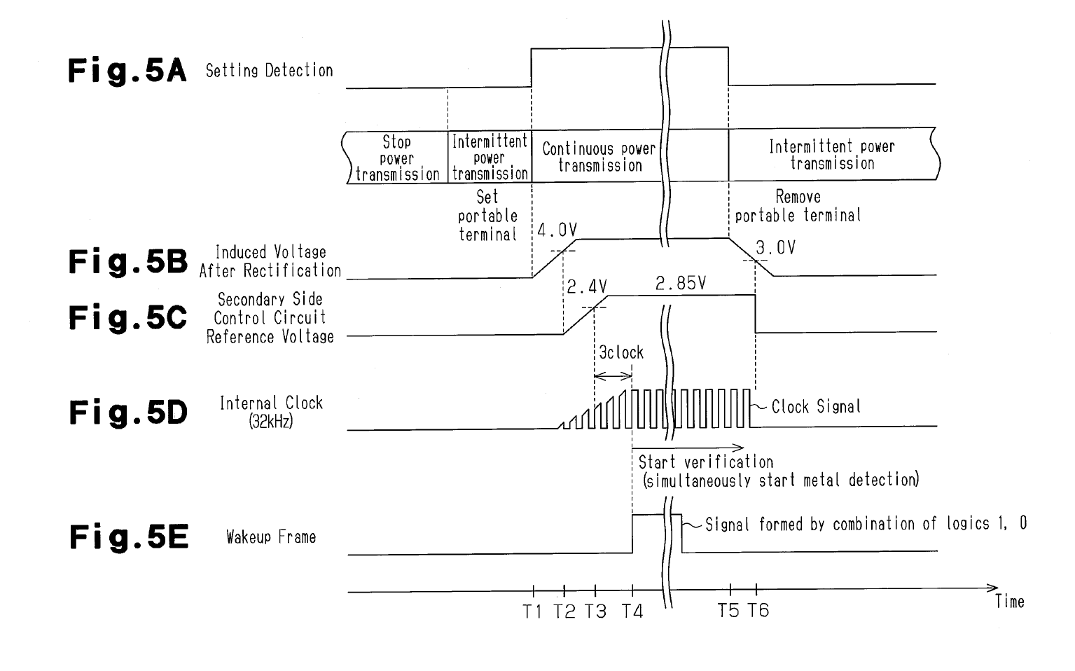

A contactless charging apparatus according to one embodiment of the present invention will now be described with reference to FIGS. 1 and 5.

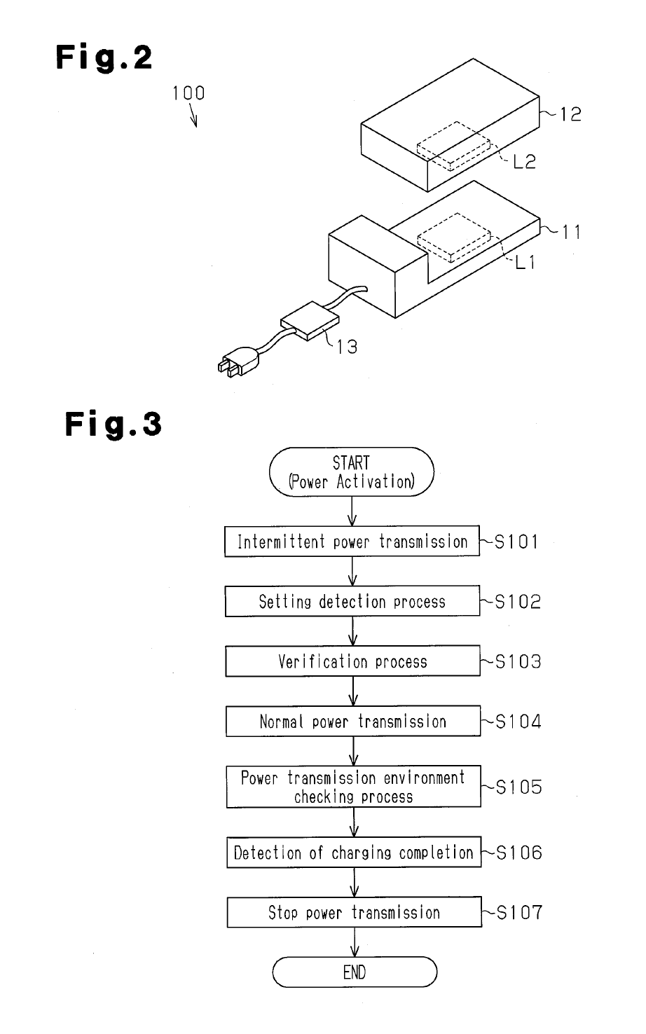

Referring to FIG. 2, a contactless charging apparatus 100 includes a power transmitting electronic device and a power receiving electronic device. The power transmitting electronic device is, for example, a charger 11, and the receiving side electronic device is, for example, a portable terminal 12. The charger 11 is connected, for example, to a commercial power (AC) via an AC adapter 13. The AC adapter 13 converts commercial power into DC power. The charger 11 converts the converted DC power back to AC power and transmits the converted AC power in a contactless manner to the portable terminal 12, which is set on the charger 11. The portable terminal 12 uses the transmitted AC power to at least charge the rechargeable battery incorporated in the portable terminal 12. Power transmission from the charger 11 to the portable terminal 12 is performed using electromagnetic coupling that occurs between a primary coil L1, which is arranged in the charger 11, and a secondary coil L2, which is arranged in the portable terminal 12. The charger 11 and the portable terminal 12 can exchange various types of information using electromagnetic coupling. In the illustrated example, information is transferred from the charger 11 to the portable terminal 12 through frequency modulation, and information is transferred from the portable terminal to the charger 11 through load modulation. The contactless charging apparatus 100 is one example of a contactless power transmission device.

<Charger>

The structure of the charger 11 will now be described in detail.

As shown in FIG. 1, the charger 11 includes a control circuit 21 and an oscillation circuit 22. The oscillation circuit 22 is connected to the primary coil L1 and the control circuit 21. A capacitor C1 is connected between a connection node of the primary coil L1 and control circuit 21 and the oscillation circuit 22. The primary coil L1 and capacitor C1 form a resonance circuit. The control circuit 21 controls the oscillation circuit 22 and provides the resonance circuit with a signal oscillated at a predetermined frequency (AC voltage). More specifically, the oscillation circuit 22 generates AC voltage having a predetermined frequency during power transmission and supplies the generated AC voltage to the primary coil L1. During data transmission, the oscillation circuit 22 generates AC voltage having a frequency that changes in accordance with the data and supplies the generated AC voltage to the primary coil. The resonance circuit receives the signal (AC voltage) and resonates, and the primary coil L1 generates primary voltage.

The control circuit 21 is operated by DC power supplied from the AC adapter 13. The control circuit 21 centrally controls each part of the charger 11. The control circuit 21 includes a frequency modulation unit 23, a setting detection unit 24, and a signal reception unit 25.

The frequency modulation unit 23 performs a frequency modulation process. More specifically, the frequency modulation unit 23 sets a frequency in accordance with the transmitted signal. The oscillation circuit 22 generates AC power (AC voltage) that oscillates at the frequency set by the frequency modulation unit 23. For example, when the charger 11 transmits logic “1” from the charger 11 to the portable terminal 12, the frequency modulation unit 23 sets frequency f1, and the oscillation circuit 22 generates AC voltage having the set frequency f1. When logic “0” is transmitted, the frequency modulation unit 23 sets frequency f2, and the oscillation circuit 22 generates AC voltage having the set frequency f2.

The setting detection unit 24 detects whether or not the portable terminal 12 is set on the charger 11 based on induced voltage of the primary coil L1. More specifically, in accordance with the positional relationship of the primary coil L1 and the secondary coil L2, the voltage level (amplitude) at the AC voltage induced at the primary coil L1 changes. When the portable terminal 12 approaches the primary coil L1, the inductance of the oscillation circuit (L1 and C1) increases, and the voltage generated at the primary coil K1 decreases. Thus, the value of the induced voltage of the primary coil L1 increases in the order of a state in which the portable terminal 12 is set and a state in which the portable terminal 12 is not set. In the illustrated example, the setting detection unit 24 monitors the induced voltage at the primary coil L1 and compares the monitored induced voltage of the primary coil L1 with a setting determination threshold stored in a storage device (not shown) of the control circuit 21 to detect the setting of the portable terminal 12.

The setting determination threshold sets the voltage induced at the primary coil L1 when the portable terminal 12 is not set as a reference. When the voltage induced at the primary coil L1 is less than the setting determination threshold, the setting detection unit 24 determines that the portable terminal 12 is set on the charger 11. When the voltage induced at the primary coil L1 is greater than or equal to the setting determination threshold, the setting detection unit 24 determines that the portable terminal 12 is not set on the charger 11. The setting detection unit 24 can also detect removal of the portable terminal 12 from the charger 11 based on the induced voltage of the primary coil L1. That is, when the induced voltage of the primary coil L1 changes from a value less than the setting determination threshold to a value greater than or equal to the setting determination threshold, the setting detection unit 24 determines that the portable terminal 12 has been removed from the charger 11.

The signal reception unit 25 demodulates a load modulated signal provided from the portable terminal 12. More specifically, the portable terminal 12 performs load modulation to transmit data to the charger 11. However, the induced voltage at the primary coil L1 changes in correspondence with the load modulation. In the portable terminal 12, for example, when the load is decreased to transmit logic “0,” the amplitude (peak voltage) of the induced voltage at the primary coil L1 is decreased.

Further, in the portable terminal 12, when the load is increased to transmit logic “1”, the amplitude of the induced voltage at the primary coil L1 is increased. The signal reception unit 25 performs a peak-hold process or the like on the amplitude of the induced voltage and compares the peak voltage with a threshold (voltage value) to determine whether the data from the portable terminal 12 is logic “0” or “1”.

A current sensor 26 detects current input to the control circuit 21 from the commercial power supply (more precisely, the AC adapter 13).

The foreign object detection unit 27 detects a metal foreign object based on a value of a current detected by the current sensor 26. More specifically, as the portable terminal 12 or a metal foreign object approaches the primary coil L1, the inductance of the resonance circuit (L1 and C1) changes. This changes the value of the voltage generated at the primary coil L1. More specifically, the induced voltage at the primary coil L1 increases in the order of a state in which the portable terminal 12 is set, a state in which a metal object is proximal, and a state in which the portable terminal 12 is not set. In other words, in accordance with whether or not the portable terminal 12 is set on the charger 11 and whether or not the metal foreign object is present, the value of the current input to the control circuit 21 and the value of the current generated at the primary coil L1 increase in the order of (A), (B), (C), and (D), which are listed below.

(A) The portable terminal 12 is set and a metal foreign object is present (minimum).

(B) The portable terminal 12 is set and a metal foreign object is not present.

(C) The portable terminal 12 is not set and a metal foreign object is not present (minimum).

(D) The portable terminal 12 is not set and a metal foreign object is present (maximum).

Thus, by setting a foreign object determination threshold (current value) based on the value of a current input to the control circuit 21 in state (A), a metal foreign object can be detected in a state in which the portable terminal 12 is set on the charger 11. Further, by setting a foreign object determination threshold (current value) based on the value of a current input to the control circuit 21 in state (C), a metal foreign object can be detected in a state in which the portable terminal 12 is not set on the charger 11. When the value of the current detected by the current sensor 26 exceeds the foreign object determination threshold, the foreign object detection unit 27 determines that a foreign object is proximal to the primary coil or that a metal is arranged between the primary coil L1 and the secondary coil L2. The illustrated example uses only a foreign object determination threshold set based on state (A).

The control circuit 21 centrally controls each part of the charger 11. The control circuit 21 monitors the induced voltage at the primary coil L1 with the setting detection unit 24 included in the control circuit 21 to detect whether or not the portable terminal 12 is set on the charger 11. Further, the control circuit 21 monitors the value of the input current supplied from the foreign object detection unit 27, which is included in the control circuit 21, to detect a metal foreign object. The control circuit 21 controls the mode for supplying power to the portable terminal 12 in accordance with the detection result.

<Portable Terminal>

The structure of the portable terminal 12 will now be described in detail.

As shown in FIG. 1, the portable terminal 12 includes a rectification circuit 31, a control circuit 32, and a rechargeable battery 33. The secondary coil L2 is connected to the rectification circuit 31.

The rectification circuit 31 converts the AC voltage induced to the secondary coil L2 into DC voltage. The DC voltage is supplied by a charging circuit (not shown) to the rechargeable battery 33. This charges the rechargeable battery. The DC voltage from the rectification circuit 31 is adjusted to a predetermined voltage level (e.g., 5 V) by a power supply circuit (constant voltage circuit), which is not shown. This adjusts voltage is supplied to each part of the control circuit 32 as operational power. In a state in which the portable terminal 12 is set on the charger 11, the control circuit 32 is supplied with and operated by the operational power.

The control circuit 32 includes a load modulation unit 34, a signal reception unit 35, and a clock generator 36.

The load modulation unit 34 performs a load modulation process. That is, when the portable terminal 12 transmits data to the charger 11, the load modulation unit 34 changes the load (internal resistance) in accordance with the transmitted load to change the induced voltage of the primary coil L1. The load modulation unit 34 can switch the load state between a low load state and a high load state. For example, when transmitting logic “0”, the load modulation unit 34 switches the load to a low load state (large impedance). When transmitting logic “1”, the load modulation unit 34 switches the load to a high load state (small impedance). This allows for transmission of data formed by logics “0” and “1” from the portable terminal 12 via the secondary coil L2 and primary coil L1 to the charger 11.

The signal reception unit 35 demodulates a frequency modulated signal. More specifically, the signal reception unit 35 detects the frequency (f1 and f2) of the AC voltage induced at the coil end of the secondary coil L2 and generates a signal that is a combination of logics “1” and “0” with the transmission data from the charger 11 based on the detected frequency.

The clock generator 36 generates a clock signal. The control circuit 32 operates while synchronizing each of its parts based on the clock signal. The control circuit 32 generates a data frame of a signal transmitted to the charger 11 based on the clock signal. The frequency of the clock signal may be, for example, a predetermined frequency.

The control circuit 32 centrally controls each part of the portable terminal 12. Further, based on the voltage between the terminals of the rechargeable battery 33 obtained from the charge circuit described above, the control circuit 32 detects the charge amount of the rechargeable battery 33 or whether or not charging has been completed. When charging is completed, the control circuit 32 performs load modulation to transmit a charge completion notification signal.

<Operation of the Contactless Charging Apparatus>

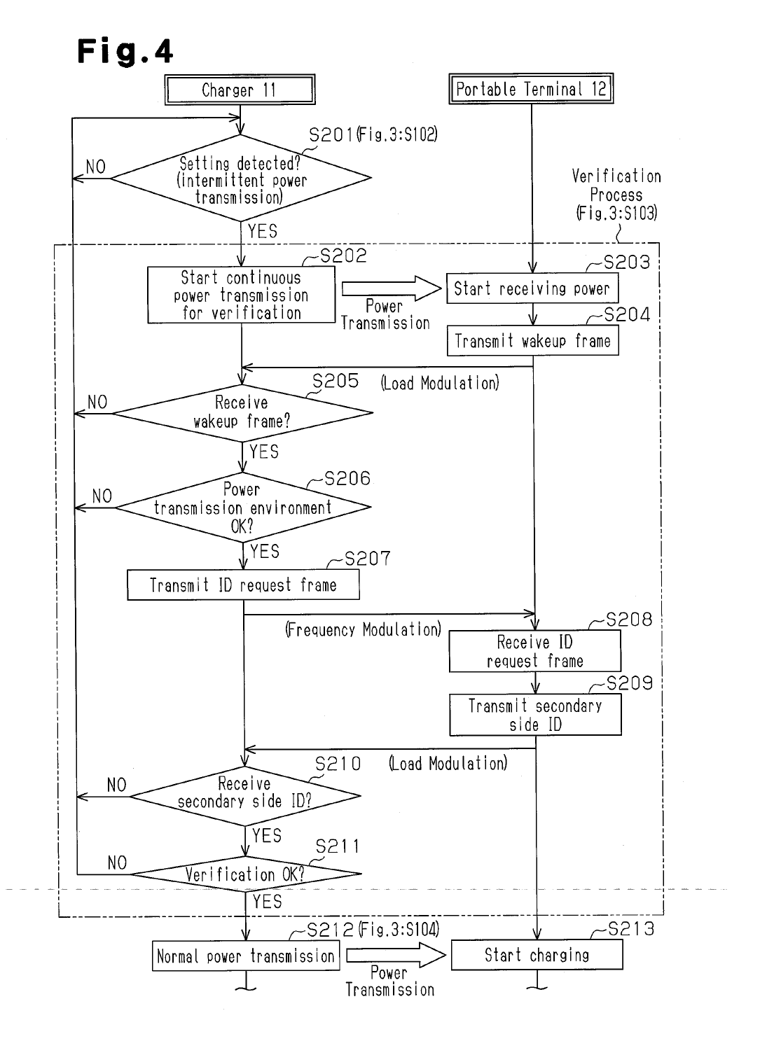

The operation of the contactless charging apparatus described above will now be described with reference to the flowchart of FIG. 3. The flowchart is executed in accordance with a control program stored in the primary side control circuit 21. The control program is executed by supplying the charger 11 with operational power. When charging the portable terminal 12, the portable terminal 12 is set on the charger 11. In this state, the magnetic flux generated at the primary coil L1 is linked with the secondary coil L2.

When the charger 11 is supplied with operational power, the control circuit 21 drives the primary coil L1 intermittently in predetermined cycles to perform intermittent power transmission (step S101).

Then, the control circuit 21 performs a setting detection process on the portable terminal 12 (step S102). The control circuit 21 detects whether or not the portable terminal 12 is set based on the AC voltage (sine wave) induced between the two ends of the primary coil L1.

When detecting the setting of the portable terminal 12, the control circuit 21 executes a process for verifying the portable terminal 12 (step S103). More specifically, to verify the authenticity of the portable terminal 12, the control circuit 21 starts continuous power transmission for verification and performs communication (exchanges information) through electromagnetic coupling with the portable terminal 12.

When the control circuit 21 verifies that the set portable terminal 12 is the correct power transmission subject, the control circuit 21 starts normal power transmission for charging (step S104). Normal power transmission for charging refers to the continuous transmission of power to charge the rechargeable battery 33 of the portable terminal 12. The power transmitted in a contactless manner from the charger 11 charges the rechargeable battery 33 of the portable terminal 12. The verification process with be described in detail later.

Then, during the normal power transmission period, the control circuit 21 performs a process for checking the power transmission environment (step S105). More specifically, the control circuit 21 performs metal foreign object detection based on the detection result of the current sensor 26. When a metal foreign object is detected, the control circuit 21 stops the normal power transmission and ends the processing. When a metal foreign object is undetected, the control circuit 21 waits until charging is completed.

When the control circuit 21 detects completion of the charging of the portable terminal 12 (step S106), the control circuit 21 stops normal power transmission (step S107) and ends the processing. Upon receipt of a charging completion notification transmitted from the portable terminal 12, the control circuit 21 recognizes completion of the charging.

Afterward, the processes of S101 to S107 are repetitively performed as long as power is supplied.

As described above, when a detection process for a metal foreign object is performed during the normal power transmission period but a metal foreign object has already been arranged between the charger 11 and the portable terminal 12 before the normal power transmission starts, the metal foreign object cannot be detected until the normal power transmission starts. In this case, during the period from when continuous power transmission for verification starts to when normal power transmission for charging starts and thereby initiates the detection process for a metal foreign object, the metal foreign object may be heated when receiving the continuous power transmission for verification. In the present example, the procedures of the verification process described below are performed to detect a metal foreign object before the normal power transmission starts, more specifically, during the period in which the verification process is executed.

<Verification Process>

The verification process of the portable terminal 12 performed between the charger 11 and the portable terminal 12 will now be described with reference to the operation sequence diagram of FIG. 4. The verification process is executed in step S103 of the flowchart shown in FIG. 3.

As shown in FIG. 4 and described above, when the control circuit 21 of the charger 11 detects the setting of the portable terminal (step S201), the control circuit 21 starts continuous power transmission for verification to verify the portable terminal 12 (step S202).

When the control circuit 32 of the portable terminal 12 receives the power transmitted for verification (step S203), the control circuit 32 generates a wakeup frame and performs load modulation to transmit the generated wakeup frame. The wakeup frame is a signal including information indicating that the receipt of power from the charger 11 has resulted in normal activation and a stable operation state. The wakeup frame has a frame configuration of, for example, 25 bits (communication speed 833 μs/bit).

After starting the continuous transmission for verification in step S202, the control circuit 21 of the charger 11 determines whether or not a wakeup frame has been received (step S205). When a wakeup frame is not received within a fixed period from when continuous power transmission for verification starts in step S202 (NO in step S205), the control circuit 21 proceeds to step S201. More specifically, the control circuit 21 stops continuous power transmission for verification and performs intermittent power transmission again. In contrast, when a wakeup frame is received within the fixed period (YES in step S206), the control circuit 21 executes a process for checking the power transmission environment (step S206).

More specifically, the control circuit 21 determines whether or not a metal foreign object is present based on the value of the current detected by the current sensor 26. When determining that a metal foreign object is present (NO in step S206), the control circuit 21 proceeds to step S201. More specifically, the control circuit 21 stops continuous power transmission for verification and performs intermittent power transmission again. The heating of the metal foreign object is suppressed by stopping continuous power transmission for verification. In contrast, when determining that a metal foreign object is not present (YES in step S206), the control circuit 21 generates an ID request frame and performs frequency modulation to transmit the generated ID request frame (step S207). More specifically, the control circuit 21 changes the oscillation frequency with the frequency modulation unit 23 to change the amplitude of the AC voltage induced at the primary coil L1. The control circuit 21 generates from the amplitude change an ID request frame, which is an electric signal of the combination of logics “1” and “0”, and transmits the ID request frame to the portable terminal 12. The ID request frame is a signal that indicates a request for transmission of identification information (ID), which is unique to the portable terminal 12, to the portable terminal 12.

When the control circuit 32 of the portable terminal 12 receives the ID request frame (step S208), the control circuit 32 reads the identification information stored in its storage device and performs load modulation on the identification information to transmit a verification signal to the charger 11 (step S209).

After transmitting the ID request frame in step S207, the control circuit 21 of the charger 11 determines whether or not a verification signal, or identification information, has been received from the portable terminal 12 (step S210). When identification information is not received within a fixed period (NO in step S210), the charger 11 proceeds to step S201. More specifically, continuous power transmission for verification is stopped, and intermittent power transmission is performed again. In contrast, when identification information is received within the fixed time (YES in step S210), the control circuit 21 determines the authenticity of the received identification information (step S211). More specifically, the control circuit verifies the received identification information of the portable terminal 12 with verification information stored in its storage device. When the verification is unsuccessful (NO in step S211), the control circuit 21 proceeds to step S201. More specifically, continuous power transmission for verification is stopped, and intermittent power transmission is performed again. In contrast, when verification of the identification information with the identification information of the portable terminal 12 is successful (YES in step S211), the control circuit 21 determines that the portable terminal 12 that transmitted the identification information, that is, the presently set portable terminal 12, is the correct power transmission subject and starts normal power transmission for charging (step S212).

The portable terminal 12 uses the power transmitted for charging to start charging the rechargeable battery 33 (step S213).

<Operation when Activating Portable Terminal 12>

In the operation sequence of FIG. 4, the operation of the portable terminal 12 from when power is received in step S203 to when a wakeup frame is transmitted in step S204 will now be described in detail with the activation sequence of FIG. 5.

As shown in FIG. 5A, when the portable terminal 12 is set on the charger 11 and continuous power transmission for verification is started (timing T1), the value of the DC voltage generated by the secondary coil L2 and the rectification circuit 31 gradually increases as shown in FIG. 5B.

Then, as shown in FIG. 5C, when the voltage level of the DC voltage reaches the activation voltage (here, 4 V) of the secondary side control circuit 32 (timing T2), the value of a reference voltage in the control circuit 32, that is, the internal voltage that drives internal circuits in the control circuit, gradually increases.

As shown in FIG. 5D, as the reference voltage in the control circuit 32 increases, the generation of an internal clock starts. As shown in FIG. 5C, when the reference voltage of the control circuit 32 reaches the minimum reference voltage (here, 2.4 V) for driving its internal circuits (timing T3), after three clocks (approximately 100 μS) elapses, the control circuit 32 transmits a wakeup frame. The wakeup frame is transmitted at a timing at which the operation of the control circuit 32 is stabilized. The timing at which the operation of the control circuit 32 stabilizes differs depending on the specification of the control circuit 32. As described above, in the charger, the receipt of the wakeup frame triggers the verification process of the portable terminal 12 and the detection process for a metal foreign object at the same time or in parallel. At this point of time, when a metal foreign object is present, the metal foreign object is detected at an early stage without waiting for the normal power transmission for charging (S104 in FIG. 3 and S212 in FIG. 4).

As shown in FIG. 5A, when the portable terminal 12 is removed from the charger 11, continuous power transmission for charging is stopped, and intermittent power transmission is started again to detect whether or not the portable terminal 12 is set (timing T5). This gradually decreases the level of the DC voltage generated by the rectification circuit 31. When the level of the DC voltage becomes lower than the activation voltage of the control circuit 32 (here, 3 V), the reference voltage in the control circuit 32 gradually decreases. This stops the generation of the internal clock (timing T6).

In this manner, immediately after the secondary side control circuit 32 is activated by the DC voltage generated by the rectification circuit 31, the verification operation of the portable terminal 12 is started. Thus, even when a metal foreign object is arranged between the charger 11 and the portable terminal 12 before shifting to the verification operation, a metal foreign object can be detected at an early stage by shifting to the verification process, which allows for detection of a metal foreign object, at an earlier stage. This prevents in a preferred manner a heated metal foreign object from being touched and the frame of the portable terminal 12 from being thermally deformed. This ensures a higher reliability.

In the prior art apparatus described in the Background Art section, after activation of the secondary side control circuit, the control circuit detects whether the portable terminal is set on the charger at a proper position and determines whether or not to proceed to a process for verifying the portable terminal in accordance with the position detection result. Load modulation is performed to transfer the position detection result from the portable terminal to the charger. Thus, the time from when continuous power transmission for verification is started to when shifting to the verification process requires, at minimum, the communication time for load modulation (e.g., 100 ms or longer).

In contrast, in the contactless charging apparatus 100 of the present example, a process such as position detection of the charger 11 after activation of the control circuit 32 is omitted. Further, immediately after the secondary side control circuit 32 is activated, a wakeup frame indicating the activation is transmitted. When receiving the wakeup frame, the primary side control circuit 21 immediately shifts to the detection process for a metal foreign object and the verification process for the portable terminal 12. As described above, the wakeup frame has a frame configuration of 25 bits (communication speed 833 μs/bit). That is, the time required to transmit a wakeup frame is 20.825 ms. In this manner, the contactless charging apparatus 100 of the present example shifts to the metal foreign object detection process and the verification process within an extremely shift time from when the secondary side control circuit 32 is activated.

### Advantages of the Embodiment

(1) Immediately after activation, the control circuit 32 of the portable terminal 12 transmits an electric signal (wakeup frame) to the charger 11. The receipt of the wakeup frame triggers the control circuit 21 of the charger 11 to start the verification process of the portable terminal and the detection process for a metal foreign object. Thus, a metal foreign object can be detected at an early stage without waiting for normal power transmission for charging.

(2) After the reference voltage of the secondary side control circuit 32 reaches the minimum voltage level required for driving its internal circuits, when three clocks elapse, the control circuit 32 determines that activation has occurred normally and transmits a wakeup frame. Thus, the wakeup frame is generated when the internal clock of the control circuit 32 is stabilized and transmitted at a timing at which the control circuit 32 stably operates. In this manner, at the secondary side control circuit 32, the verification process of the portable terminal 12 and the detection process for a metal foreign object are started at the earliest timing at which a normal signal can be generated through load modulation.

(3) The control circuit 21 of the charger 11 performs a comparison process on the value of a current supplied to the control circuit 21 as an input current from a commercial power supply, more precisely, the AC adapter 13, which is an external power supply, and an abnormality determination threshold. When the value of the detected current exceeds the abnormality threshold value, the control circuit determines that a metal foreign object is present. In this manner, a metal foreign object can easily be detected by monitoring changes in the current input to the control circuit 21.

(4) The portable terminal 12 can use the power transmitted in a contactless manner from the charger 11 to charge the rechargeable battery 33.

(5) In a standby state in which the setting of the portable terminal 12 is not detected by the setting detection unit 24, power is intermittently transmitted. When the setting of the portable terminal 12 is detected by the setting detection unit 24, power is continuously supplied. Thus, power consumption can be suppressed in a standby state that waits for the setting of the portable terminal 12. This differs from when continuously transmitting power.

(6) The charger 11 determines from the identification information transmitted from the portable terminal 12 whether or not the portable terminal 12 is the correct transmission subject. When determined that it is the correct transmission subject, normal power transmission for charging is continuously performed. When determined that the transmission subject is not correct, the charger 11 returns to the initial state in which power is intermittently supplied. This prevents unnecessary power from being supplied to an incorrect transmission subject.

(7) In the illustrated example, verification power supplied from the power transmitting device to the power receiving device is AC power having a modulated frequency and oscillated by the power transmitting device. Charging power and normal power supplied from the power transmitting device to the power receiving device is AC power having a predetermined frequency and oscillated by the power transmitting device. In this case, electromagnetic coupling between the primary coil L1 and the secondary coil L2 can be used for both verification and charging.

### Other Embodiments

In the present example, the wake up frame is transmitted if three clocks elapse from when the reference voltage of the control circuit 32 reaches the minimum reference voltage required to drive its internal circuits. However, the transmission timing of the wakeup frame is not limited in such a manner. The timing only needs to stabilize the secondary side internal clock. This is because the transmission timing changes in accordance with the specification of the secondary side control circuit 32.

The setting detection may be executed by the portable terminal 12. For example, when the setting position of the portable terminal 12 is improper, the DC voltage generated by the rectification circuit 31 does not reach a predetermined level. This allows for determination that the setting state is improper. The determination result is transmitted from the portable terminal 12 to the charger 11 through load modulation.

In the present example, the detection process of a metal foreign object may be performed in predetermined control cycles after the charger 11 is supplied with operational power. In this case, before the setting of the portable terminal 12 to the charger 11 is detected, a metal foreign object is detected by comparing the foreign object determination threshold, which is set based on state (C), and a value of a current input to the primary coil L1. Further, after the setting of the portable terminal 12 to the charger 11 is detected, a metal foreign object is detected by comparing the foreign object determination threshold, which is set based on state (A), and a value of a current input to the control circuit 21. Based on whether or not the portable terminal 12 is set to the charger 11, the control circuit 21 switches the foreign object determination threshold, which is used as a reference for determining whether or not a metal foreign object is present between two values.

In the present example, a metal foreign object is detected based on the value of a current input to the control circuit 21 of the charger 11. However, the detection method may be changed when required. For example, a metal foreign object may be detected based on changes in induced voltage of the primary coil L1. That is, the voltage induced at the primary coil L1 changes depending on whether or not the portable terminal 12 or a metal foreign object is proximal to the primary coil L1. More specifically, the value of the induced voltage at the primary coil L1 increases in the order of a state in which the portable terminal 12 is set, a state in which a metal foreign object is proximal, and a state in which the portable terminal 12 is not set. Accordingly, the presence of a metal foreign object can be determined by setting a foreign object determination value (voltage value) using the induced voltage at the primary coil L1 as a reference in a state in which the portable terminal 12 is set. That is, when the value of the induced voltage at the primary coil L1 exceeds a foreign object determination value, the presence of a metal foreign object can be determined.

To detect a foreign metal object, the method that will now be described can be employed. The presence of a metal foreign object is determined based on whether the control circuit 21 normally received the wakeup frame through load modulation. For example, when a metal foreign object having a large area is inserted between the primary coil L1 and the secondary coil L2, the probability is high in which a signal transmitted from the portable terminal 12 to the charger 11 is obstructed by the metal foreign object and not transmitted to the charger 11. Thus, when the wakeup frame is normally detected, it can be determined that a metal foreign object is not inserted. Further, when the wakeup frame is not normally detected, it can be determined that a metal foreign object is inserted. When the wakeup frame generated through load modulation can be normally decoded and the decoded information can be normally read, the control circuit 21 of the charger 11 determines that the wakeup frame has been normally detected. This detection method can determine a metal foreign object in a preferred manner at an early stage even when the metal foreign object has a large area and blocks the space between the primary coil L1 and the secondary coil L2.

In the present example, the power transmitted by a contactless power transmission technique is used to charge the secondary battery 33 but may be used as operation power for a secondary electric device proximal to or set on a primary side electric device. For example, a contactless power transmission system can be configured in which the secondary side electric device is operated by power transmitted from the primary side electric device.

In the present embodiment, the subject of power transmission is a portable terminal such as a cellular phone but may be various types of electronic devices, such as a watch, a cordless telephone, an electric shaver, an electric toothbrush, and a handy terminal.

<Other Technical Concepts>

Technical concepts that can be recognized from the above embodiment are listed below.

(C1) A power transmitting device that transfers power in a contactless manner to a power receiving device through electromagnetic coupling between a primary coil arranged in the power transmitting device and a secondary coil arranged in the power receiving device, the power transmitting device comprising a setting detection unit that detects that the power receiving device has been set based on a change in induced voltage at the primary coil, wherein the power transmitting device intermittently transmits power when the setting detection unit does not detect that the power receiving device has been set and continuously supplies power when the setting detection unit detects that the power receiving device is set.

In this structure, power consumption can be suppressed in a standby state that waits for the setting of the power receiving device. This differs from when power is continuously transmitted in the standby state.

(C2) The power transmitting device according to C1, wherein the power transmitting device determines whether or not the power receiving device is a correct power transmission subject based on identification information transmitted from the power receiving device supplied with the continuous power, continues to supply the continuous power when determining that the power receiving device is the correct power transmission subject, and returns to the state that supplies the intermittent power when determining that the power receiving device is not the correct power transmission subject.

In this structure, when determined that the power receiving device is not correct, the mode for supplying power to the power receiving device is switched from a continuous mode to an intermittent mode. As a result, an incorrect power receiving device is not supplied with unnecessary power.

### Description of Reference Characters

11: charger (power transmitting device)

12: portable terminal (power receiving device)

21, 32: control circuit

33: rechargeable battery

36: clock generator

1. A contactless power transmission device comprising:
a power transmitting device; and
a power receiving device,
wherein
the power receiving device is activated when receiving verification power transmitted in a contactless manner from the power transmitting device using electromagnetic coupling between the transmission device and the power receiving device,
after the power receiving device is activated, the power transmitting device transmits normal power to the power receiving device when verification of the power receiving device is successfully performed through communication using the electromagnetic coupling,
the power receiving device transmits to the power transmitting device an electric signal indicating activation immediately after being activated upon receipt of the verification power, and
reception of the electric signal triggers the power transmitting device to start a verification process on the power receiving device and perform a detection process for a metal foreign object.

2. The contactless power transmission device according to claim 1, wherein
the power receiving device includes a clock generator that generates a clock signal used to generate a data frame of a signal transmitted to the transmission device when supplied with power, and
the power receiving device transmits the electric signal when determining activation at a timing at which the clock generator stably generates the clock signal.

3. The contactless power transmission device according to claim 1, wherein as the detection process for a metal foreign object, the power transmitting device detects an input current from an external power supply, performs a comparison process on the value of the detected current and a preset foreign object determination threshold, and determines that a metal foreign object is present when the value of the detected current exceeds the foreign object determination value.

4. The contactless power transmission device according to claim 1, wherein the power receiving device includes a rechargeable battery and uses power transmitted in a contactless manner from the power transmitting device to charge the rechargeable battery.

5. The contactless power transmission device according to claim 1, wherein
the verification power and the normal is transmitted by the electromagnetic coupling from the power transmitting device to the power receiving device,
the verification power is AC power oscillated from the power transmitting device and having a modulated frequency, and
the normal power is AC power oscillated from the power transmitting device and having a predetermined frequency.

6. The contactless power transmission device according to claim 5, wherein the power receiving device transmits the electric signal indicating activation to the power transmitting device after receiving the verification power and before receiving the normal power.
